(19) United States
(12) Patent Application Publication
(10) Pub. No.: US 2006/0231505 A1
(43) Pub. Date: Oct. 19, 2006

(54) Synergistic biocidal mixtures

(76) Inventors: Michael J. Mayer, Jacksonville, FL (US); Freddie L. Singleton, Switzerland, FL (US); John M. Cronan, Jacksonville, FL (US)

Correspondence Address: HERCULES INCORPORATED;HERCULES PLAZA, 1313 NORTH MARKET STREET, WILMINGTON, DE, 19894-0001, US

(21) Appl. No.: 11/269,412

(22) Filed: Nov. 8, 2005

Related U.S. Application Data
(63) Continuation-in-part of application No. 10/266,509, filed on Oct. 8, 2002, now Pat. No. 7,008,545.
(60) Provisional application No. 60/405,235, filed on Aug. 22, 2002.

(51) Int. Cl. C02F 1/68

(52) U.S. Cl. 210/764

(57) ABSTRACT

Synergistic mixtures of haloamines and non-oxidizing biocides and their use to control the growth of microorganisms in aqueous systems is provided. The methods entail adding an effective amount of at least one haloamine and at least one non-oxidizing biocide to an aqueous system thereby producing a biocidal synergistic effect.

### CROSS REFERENCE TO RELATED APPLICATIONS

This application is a continuation-in-part of U.S. Ser. No. 10/266,509, filed Oct. 8, 2002, which in turn claims priority to U.S. Ser. No. 60/405,235, filed Aug. 22, 2002, the disclosures of each of which are incorporated herein by reference in their entireties.

### FIELD OF THE INVENTION

The present invention relates to the synergistic mixtures (or combinations) of biocides and their use to control the growth of microorganisms in aqueous systems, more particularly in industrial process waters, and most particularly in pulp and paper process systems.

### BACKGROUND OF THE INVENTION

Uncontrolled growth of microorganisms can have serious consequences such as degradation or spoilage of products, contamination of products, and interference with a wide range of important industrial processes. Growth of microorganisms on surfaces exposed to water (e.g., recirculation systems, heat exchangers, once-through heating and cooling systems, pulp and paper process systems, etc.) can be especially problematic, because biofilms can be formed by the indigenous microbial species. Depending on the environment, biofilms may develop into thick gelatinous-like masses and are referred to as slime. Slime producing microorganisms include bacteria, airborne microorganisms, sulfate reducing bacteria, filamentous bacteria, spore forming bacteria, fungi, and algae.

Slime formation becomes especially problematic in industrial settings, because the presence of slime can interfere with a range of processes, systems, and production. As an example, slime deposits deteriorate cooling towers made of wood and promote corrosion when deposited on the metal surfaces of cooling water systems. Furthermore, slime deposits tend to plug or foul pipes, valves and flow meters and reduce heat exchange or cooling efficiency on heat exchange surfaces.

The quantity and quality of paper production can be adversely affected by slime formation. Pulp and paper mill systems operate under conditions which encourage the growth of microorganisms and often results in fouling problems. Moreover, microorganisms can form large slime deposits which can become dislodged from system surfaces and become incorporated into the paper, which results in increased breaks and tears in the sheet. Furthermore, slime can cause unsightly blemishes or holes in the final product, which results in a lower quality product or the product being rejected. This necessitates shutting down the paper making process to clean the equipment, which results in the loss of production time.

Slime may also be objectionable from the standpoint of cleanliness and sanitation in breweries, wineries, dairies and other industrial food and beverage process water systems. Moreover, sulfate reducing bacteria are often problematic in waters used for the secondary recovery of petroleum or for oil drilling in general. Sulfate reducing bacteria can form slime deposits. However, the real problem with sulfate reducing bacteria is that they become incorporated into well-established biofilms and generate by-products that have highly offensive odors, are toxic, and can cause corrosion of metal surfaces by accelerating galvanic action. For example, these microorganisms reduce sulfates present in the injection water to generate hydrogen sulfide. Hydrogen sulfide has a highly offensive odor (i.e., rotten egg smell), is corrosive and reacts with metal surfaces to form insoluble iron sulfide corrosion products.

The proliferation of bacteriological contamination in lubricants and cutting fluids is a common problem due to the elevated temperatures and unsanitary conditions found in many metal working plants. It is often necessary to discard these fluids due to microbiological contamination.

In order to control the foregoing problems in various industrial processes, numerous antimicrobial agents (i.e., biocides) have been employed to eliminate, to inhibit or to reduce microbial growth. These biocides are used alone or in combination to prevent or control the problems caused by growth of microorganisms.

Biocides are classified as oxidizing or non-oxidizing, depending on their chemical composition and mode of action. Whether an oxidizing or non-oxidizing biocide is used alone or in combination is dependent upon the problematic microorganism(s), the nature of the medium to which the biocide is added, as well as specific requirements of the industry, including safety and regulatory considerations.

Oxidizing biocides have been widely used in the industry for decades, especially in pulp and paper production where strong oxidizers have been used to control microbial populations in the papermaking systems. An important aspect of using an oxidizing biocide as a microbiological control program is to apply quantities sufficient to maintain a free oxidizer residual in the process. This can be problematic in process waters that contain high concentrations of dissolved and particulate inorganic and organic materials. Such process waters exhibit a high and variable “demand” on the oxidizer (i.e., the oxidizer can react with the inorganic and organic materials and be rendered ineffective as a biocide). The type and amount of inorganic and organic materials within the process streams, therefore, will determine the demand. For example, oxidizing biocides are consumed by inorganic species such as ferrous iron, reduced manganese, sulfides, sulfites, etc. as well as organic compounds such celluosic fibers and additives. Thus, the demand of a system will increase with increasingly higher concentrations of inorganic and organic materials along with adverse physical conditions such as temperature and pH within those systems.

In order to overcome the demand of a system and achieve an oxidizer residual sufficient quantities of the oxidizer must be added to surpass the demand. Although it is technically simple to feed quantities of oxidizing biocides to exceed the demand, this is often not practical. Not only do treatment costs increase with higher addition rates, but many adverse side effects in the industrial system can be manifested. The adverse effects will be system dependent.

In papermaking systems, strong oxidizers, such as sodium hypochlorite, are often used for controlling the growth of microorganisms in order to prevent adverse effects on the papermaking process. Frequently, however, strong oxidizers such as sodium hypochlorite can cause more problems on the machine than they remedy. In papermaking systems, the side effects of strong oxidizers can be, among others, increased corrosion rates, increased consumption of dyes and other costly wet end chemicals (e.g., brighteners, dry and wet strength additives, and sizing agents), and reduced felt life.

Because of the inherent reactivity of chlorine and related strong oxidizers with non-biological organic and inorganic materials, it is desirable to have the oxidizer in a form that would have antimicrobial activity but be less reactive with non-biological materials. Therefore, haloamines are used to avoid some of the problems associated with the use of strong oxidizers.

Haloamines are produced by mixing an appropriate amine-containing compound with a halogenated oxidizer. Chloramines are the haloamines most commonly used in water treatment and can be produced via a process referred to as chloramination; this process can be carried out by either (1) adding chlorine to a water system that contains a known, low concentration of ammonia, or (2) adding ammonia to a water system that contains a known, low concentration of chlorine. In either situation, the chlorine and ammonia will react in situ to form chloramine. Chloramines generated from reacting chlorine and ammonia include monochloramine (NH₂Cl), dichloramine (NHCl₂), and trichloramine (NCl₃). Two of the important parameters that determine which chloramine species will exist in a system are pH and the ratio of Cl to N.

Chloramines are attractive for water treatment because of their stability in situ, ease of application and monitoring, and low capital and operational costs. Chlorine, as a gas or liquid, and ammonia are commonly combined to form chloramines. However, other substances containing an amine (RNH₂) group can also form chloramines. Other commonly used amine sources used for generating chloramines include ammonium sulfate, ammonium chloride. In U.S. Pat. No. 6,478,973, Barak taught that ammonium bromide can be used as a source of chloramines.

Methods for production of chloramines in highly concentrated form, including anhydrous chloramine, have been patented (U.S. Pat. Nos. 2,678,258; 2,837,409; 3,038,785; 2,710,248; and 3,488,164 the contents of each is herein incorporated by reference).

Chloramines have been described for different uses in water treatment. For example, chloramines were used to control aftergrowth and biofouling in the surface seawater reverse osmosis plants [(Desalination 74, 51-67 (1989), Applegate et al. (U.S. Pat. No. 4,988,444)]. Likewise, Satoshi et al. (JP7124559) demonstrated the use of ammonium chloride and sodium hypochlorite to treat water in reverse osmosis systems. Chloramines have also been used to treat highly turbid waste water when longer contact times were allowed (Atasi Khalil Z. et al.; Proc. Annu. Conf. Am. Water Works Assoc., 1988 (Pt. 2), pp. 1763-1770).

Ammonium bromide activated with sodium hypochlorite has been shown to be an effective biocide for industrial applications (U.S. Pat. No. 5,976,386). This biocide is especially effective in pulp and paper process systems. Specifically, ammonium bromide is effective in reducing the total microbial community within a system (i.e., sessile as well as planktonic bacteria) and in helping in the removal of slime deposits from surfaces while not interfering with other pulp and paper process and functional additives (e.g., wet and dry strength additives, size agents, dyes, etc) as in other common oxidizer programs.

Of the chloramines, monochloramine is most frequently used to treat water for controlling growth of microorganisms in water and wastewater systems. Studies have shown that the pH of an aqueous system affects the efficacy of monochloramine; the efficacy increases as pH decreases (see Ward et al., 1984; Pretorius and Pretorius, 1999). Other physical and chemical parameters of a system can affect the efficacy of chloramines by influencing the stability of the compounds (Ward et al., 1984, Vikesland et al. 2001). Vikesland et al. (2001) demonstrated that parameters such as pH, temperature, and the presence of other chemicals influence the stability of monochloramine in water.

Although widely practiced for treating municipal water distribution systems, chloramines are not commonly used in industrial systems. Chloramines are effective biocides but less reactive than hypochlorite and other strong oxidizers with non-biological materials that are present in some types of industrial process waters.

Although monochloramine is usually used alone, there are reports of using monochloramine in conjunction with hydrogen peroxide (U.S. Pat. Nos. 4,239,622 and 4,317,813) or ozone (Rennecker et al., 2001). However, the use of chloramines in conjunction with non-oxidizing biocides has not been reported. As described herein, combinations of haloamines and non-oxidizing biocides were found to be synergistic at inhibiting microorganisms.

### SUMMARY OF THE INVENTION

The present invention is directed to synergistic mixtures (or combinations) of haloamines and non-oxidizing biocides useful for inhibiting microorganism growth in aqueous systems.

The present invention further provides methods for controlling the growth of microorganisms in aqueous systems, such as industrial process waters, by adding an effective amount of haloamine and non-oxidizing biocide to the aqueous system, where the effective amount results in synergy as evidenced by a synergy index (SI) of less than 1.

The novel mixtures (or combinations) and processes (methods) incorporating the composition of the present invention show unexpected synergistic activity against microorganisms. Specifically, the invention is directed to the mixtures or (combinations) of haloamines (such as chloramines) and non-oxidizing biocides, and the methods of applying the haloamine and at least one non-oxidizing biocide to an aqueous system to result in a synergistic antimicrobial effect in which the microorganisms are inhibited to an extent greater than the theoretical sum of the effects of the individual actives.

### BRIEF DESCRIPTION OF THE DRAWINGS

FIG. 1 shows absorbance profiles of monochloramine (NH₂Cl) (solid line) and dichloramine (NHCl₂) (dashed line) solutions.

### DETAILED DESCRIPTION

The present invention is directed to novel synergistic biocidal mixtures (or combinations) comprising at least one haloamine and at least one non-oxidizing biocide. These novel synergistic biocidal mixtures (or combinations) when used in combination are effective in inhibiting or controlling the growth of microorganisms in aqueous systems. The present invention is also directed to a method of inhibiting or controlling the growth of microorganisms by administering an effective amount of at least one haloamine and at least one non-oxidizing biocide to an aqueous system to result in a synergy index of less than 1 as defined herein. An “effective amount” is meant to refer to the amount of haloamine and non-oxidizing biocide that provides a synergistic antimicrobial effect which is a greater than would be expected for an additive effect. In some embodiments, the effective amount of haloamine and non-oxidizing biocide is further meant to include a weight ratio of haloamine to non-oxidizing biocide that results in synergy. An “effective amount” can also be referred to as a “synergistically effective amount.”

The combinations of haloamines and non-oxidizing biocides unexpectedly provides enhanced biocidal activity which is greater than that of the individual components which make up the mixture (or combinations) and greater than the theoretical additive effect. The microbicidal mixtures (or combinations) of the present invention possess a high degree of slimicidal activity which could not have been predicted from the known activities of the individual ingredients comprising the combinations. The enhanced activity of the mixtures (or combinations) permit a significant reduction in the total quantity of the biocide required for an effective treatment of an aqueous system.

The terms “amine” and “amine groups” refer to a compound with the chemical formula of R—NH₂ wherein R is H or another moiety. The terms “halogenated amine” and “haloamine” are defined as chemicals with having one or more halogen atoms (Cl, Br, F, or I) associated with (i.e., bonded to) an amine group, and which possess antimicrobial activity. Halogenated amines or haloamines are formed by chemical reactions in which a halogenated oxidizer reacts with an amine (or amine source) to yield a product or products containing a halogenated amine group exemplified, for example, with the chemical formula X—NHR, X₂NR, and/or X₃N where in X is a halogen selected from the group of Cl, Br, F, or I and R is H or non-H moiety. If the halogen is chlorine, the haloamines formed are termed chloramines. Likewise, if the halogen is bromine, the haloamines are termed bromamines, etc.

Example amines (or amine sources) used in the present invention include, but are not limited to, ammonium salts, wherein the term “ammonium salt” is meant to exclude quaternary ammonium salts. Additional suitable amines included ammonium hydroxide, ethanolamine, ethylenediamine, diethanolamine, triethanolamine, triethylenetetramine, dibutylamine, tributylamine, glutamine, diphenylamine, hydrazine, non-halogenated hydantoins, urea, guanidine, biguanidine, sulfamate, primary and secondary nitrogen containing polymers, and combinations thereof. Examples of ammonium salts include, but are not limited to, ammonium acetate, ammonium bicarbonate, ammonium bromide, ammonium carbonate, ammonium chloride, ammonium citrate, ammonium nitrate, ammonium oxalate, ammonium persulfate, ammonium phosphate, ammonium sulfate, ferric ammonium sulfate, ferrous ammonium sulfate, ammonium sulfamate, and combinations thereof. In some embodiments, the amine source is ammonium bromide or ammonium sulfate. In some embodiments, the amine source is ammonium sulfate.

Example halogenated oxidizers used in the present invention include, but are not limited to, chlorine, hypochlorite, hypochlorous acid, chlorinated isocyanurates, bromine, hypobromite, hypobromous acid, bromine chloride, halogenated hydantoins, and combinations thereof. Non-halogenated oxidizers such as ozone and peroxides such as perborate, percarbonate persulfate, hydrogen peroxide, and peracetic acid, could be used in the present invention if a source of halogen atoms is also available in the reaction mixture.

In a particularly advantageous embodiment of the invention, the oxidant is hypochlorite, either sodium hypochlorite or calcium hypochlorite and the amine source is ammonium sulfate.

In another advantageous embodiment of the invention, the haloamine is formed by the reaction of ammonium chloride with sodium hypochlorite.

In yet another advantageous embodiment of the invention, the haloamine is formed by a combination of an amine selected from ammonium sulfate, ammonium hydroxide, ammonium phosphate, and ammonium chloride, and a halogentated oxidizer which is sodium hypochlorite.

In another advantageous embodiment of the invention, the haloamine is formed by combination of a non-halogenated hydantoin and sodium hypochlorite.

In some embodiments, the haloamine is monochloramine, dichloramine, or combination thereof.

Examples of the non-oxidizing biocide useful in the invention include, but are not limited to, aldehydes, formaldehyde releasing compounds, halogenated hydrocarbons, phenolics, amides, halogenated amides, carbamates, heterocyclic compounds containing nitrogen and sulfur atoms in the ring structure, electrophilic active substances having a halogen group in the α-position and/or in the vinyl position to an electronegative group, nucleophilic active substances having an alkyl group and at least one leaving group, surface active agents, and combinations thereof.

The aldehyde-containing compounds can be linear, branched, or aromatic. An example of an aldehyde useful in the invention, but is not limited to, glutaraldehyde.

The formaldehyde releasing compounds are preferably halogenated, methylated nitro-hydrocarbons, for example 2-bromo-2-nitro-propane-1,3-diol (Bronopol).

The amides are preferably halogenated, for example 2,2-dibromo-3-nitrilopropionamide (DBNPA).

The heterocyclic compounds useful in the invention include thiazole and isothiazolinone derivatives.

Some examples of heterocyclic compounds include, but are not limited to, 5-chloro-2-methyl-4-isothiazolin-3-one (CMIT) and 2-methyl-4-isothiazolin-3-one (MIT).

The surface active agents useful in the invention include detergents, wetting agents and emulsifiers. Some examples of surface active agents include, but are not limited to, long chain quaternary ammonium compounds, aliphatic diamines, guanidines and biguanidines.

Some electrophilic active substances include, but are not limited to, 1,2-dibromo-2,4-dicyanobutane, 2,2-dibromo-3-nitrilopropionamide (DBN PA), bis(trichloromethyl)sulfone, 4,5-dichloro-1,2-dithiol-3-one, 2-bromo-2-nitrostyrene, 5-chloro-2-methyl-4-isothiazolin-3-one (CMIT), 2-methyl-4-isothiazolin-3-one (MIT) Additional examples of the non-oxidizing biocide useful in the invention include, but are not limited to, 2-methyl-4-isothiazolin-3-one (MIT); 5-chloro-2-methyl-4-isothiazolin-3-one (CMIT); 2-n-octyl-4-isothiazolin-3-one; 4,5-dichloro-2-(n-octyl)₄-isothiazolin-3-one; 1,2-benzisothiazolin-3-one; glutaraldehyde; ortho-phthalaldehyde; 2,2-dibromo-3-nitrilopropionamide (DBNPA); 2-bromo-2-nitrostyrene, 2-nitrostyrene; 2-bromo-4′-hydroxyacetophenone; methylene bisthiocyanate (MBTC); 2-(thiocyanomethylthio)benzothiazole; 3-iodopropynyl-N-butylcarbamate; n-alkyl dimethyl benzyl ammonium chloride; didecyl dimethyl ammonium chloride; alkenyl dimethylethyl ammonium chloride; 4,5-dichloro-1,2-dithiol-3-one; decylthioethylamine; 2-bromo-2-nitropropane-1,3-diol; n-dodecylguanidine hydrochloride; n-dodecylguanidine acetate; 1-(3-chloroallyl)-3,5,7-triaza-1-azoniaadamantane chloride; 1,2-dibromo-2,4-dicyanobutane; bis(1,4-bromoacetoxy)-2-butene; bis(1,2-bromoacetoxy)ethane; bis(trichloromethyl)sulfone; diiodomethyl-p-tolylsulfone; sodium ortho-phenylphenate; tetrahydro-3,5-dimethyl-2H-1,3,5-hydrazine-2-thione; cationic salts of dithiocarbamate derivatives; 4-chloro-3-methyl-phenol; 2,4,4′-trichloro-2′-hydroxy-diphenylether; and poly(oxyethylene(dimethyliminio)ethylene(dimethyliminio)ethylene dichloride.

In some embodiments, the non-oxidizing biocide is selected from 2,2-dibromo-3-nitrilopropionamide (DBNPA), glutaraldehyde, methylene bisthiocyanate (MBTC), thiazole derivatives, isothiazolinone derivatives, 5-chloro-2-methyl-4-isothiazolin-3-one (CMIT), 2-methyl-4-isothiazolin-3-one (MIT), 2-bromo-2-nitro-propane-1,3-diol (Bronopol), a long chain quaternary ammonium compound, an aliphatic diamine, a guanidine, biguanidine, n-dodecylguanidine hydrochloride, n-alkyl dimethyl benzyl ammonium chloride, didecyl dimethyl ammonium chloride, 1,2-dibromo-2,4-dicyanobutane, 2,2-dibromo-3-nitrilopropionamide (DBNPA), bis(trichloromethyl)sulfone, 4,5-dichloro-1,2-dithiol-3-one, 2-bromo-2-nitrostyrene, 5-chloro-2-methyl-4-isothiazolin-3-one (CMIT), 2-methyl-4-isothiazolin-3-one (MIT), and combinations thereof,

The weight ratio of haloamine to the non-oxidizing biocide can be any suitable ratio that yields a synergistic antimicrobial effect. For example, the ratio can be about 20,000:1 to about 1:10,000, about 10,000:1 to about 1:1,000, about 5,000:1 to about 1:500, about 1,000:1 to about 1:100, or about 1,000:1 to about 1:50.

In some embodiments, the weight ratio of the haloamine to the non-oxidizing biocide is from about 10,000:1 to about 1:400 and preferably from about 5,000:1 to about 1:80.

The biocidal mixtures or methods of this invention are effective for controlling and inhibiting the growth and reproduction of microorganisms in aqueous systems and additive systems. In some embodiments, the aqueous systems include industrial waters systems such as cooling water systems, pulp and paper systems, mining process waters, petroleum operations, industrial lubricants and coolants, lagoons, lakes and ponds. In addition, the aqueous systems in which the present invention can be used include, but are not limited to, those involved in, paints, leather, wood, wood pulp, wood chips, starch, clays, retention aids, sizing agents, defoamers, dry and wet strength additives, pigment slurries (e.g., precipitated calcium carbonate), proteinaceous materials, lumber, animal hides, vegetable tanning liquors, cosmetics, toiletry formulations, emulsions, adhesives, coatings, metalworking fluids, swimming pool water, textiles, heat exchangers, pharmaceutical formulations, geological drilling lubricants, and agrochemical compositions.

In some embodiments, the industrial system comprises a pulp and paper mill water system where the haloamine is introduced into one or more of the process waters comprising pulp, additives, fillers, or other materials used in papermaking.

The dosage amounts of haloamine in combination with a non-oxidizing biocide required for effectiveness in this invention generally depend on the nature of the aqueous system being treated, the level of organisms present in the aqueous system, and the level of inhibition desired. A person skilled in the art could determine the amount necessary without undue experimentation.

Concentrations of non-oxidizing biocides reported herein are in units of parts per million which is equivalent to milligrams per liter. Concentrations are expressed in ppm of the biocidally active compound.

Concentrations of haloamine reported herein are in units of milligrams per liter as measured by the amount of halogen. In the case of chloramines, concentrations reported herein are in units of milligrams per liter as measured by the amount of available (or reactive) chlorine, indicated as Cl⁻. The units, milligrams per liter as Cl⁻ (or mg/ml as Cl⁻ or mg/ml), were determined on the basis of the total available chlorine concentration in a sample according to the Hach DPD chlorine test (Hach Company, Loveland, Colo.). Total available chlorine refers to the amount of chlorine in a sample that reacts with N,N-diethyl-ρ-phenylenediamine oxalate, the indicator used in the Hach assay. To determine the amount of chloramine in a sample, an aliquot of the sample is transferred to a clean container, diluted with deionized water, as appropriate, and assayed according to the Hach DPD chlorine test. The assay measures the total amount of chlorine that can react with the indicator reagent. The reaction is measured by determining the absorbance of light at 530 nm. Therefore, for the purposes of this invention, a quantity of chloramine presented in units of mg/l signifies that amount of chloramine that contains the designated amount of milligrams per liter of reactive chlorine. Thus, for example, a sample treated with 1 mg/l of chloramine will contain a total available chlorine concentration of 1 mg/l. For haloamines other than chloramine, a person skilled in the art could determine the concentration without undue experimentation.

Typically, effective concentrations of haloamine are from about 0.1 parts per million (ppm) to about 100 ppm as measured by the concentration of halogen, preferably from about 0.5 ppm to about 50 ppm, more preferably in that range of 0.5 ppm to about 5 ppm. The amount of the selected non-oxidizing biocide used in the synergistic combination will depend on the specific chemical used. In general, the amount of the non-oxidizing biocide is from about 0.001 to about 40 ppm, from about 0.01 to about 40 ppm, or from about 0.06 ppm to about 40 ppm. Thus, with respect to the biocides, the lower and upper limits of the required concentrations substantially depend upon the specific biocide or combination of biocides used. Concentrations are measured on an “active level basis” which refers to the amount of one or more biocidally active chemicals present in a biocidal product. For example, if a product tested contains a biocidally active chemical that is present in a concentration of 1 percent by weight, the amount of product added to achieve a specific concentration is calculated on the basis of the 1% active ingredient.

In some embodiments, the amount of the haloamine ranges from about 0.1 to about 100 parts per million (ppm) by weight on an active level basis and the amount of the non-oxidizing biocide ranges from about 0.001 to about 40 ppm by weight on an active level basis.

In some embodiments, the amount of haloamine ranges from about 0.5 to about 50 ppm by weight on an active level basis and the amount of the non-oxidizing biocide ranges from about 0.001 to about 40 ppm by weight on an active level basis.

The formation of haloamines can be monitored by measuring changes in the absorbance spectra of the amine sources. For example, the presence of the haloamine chemical species used in efficacy studies can be demonstrated with a scanning spectrophotometer by measuring absorbance of light in the range of 200 nm to 350 nm. A peak at 244 nm is characteristic for monochloramine.

In the case of amine-containing compounds other than ammonium salts, the spectral profiles can be likewise used to monitor halogenation of the amine groups. For example, haloamines formed by reacting hypochlorite with a diethylenetriamine and urea have specific absorbance spectra. In order to obtain spectral profiles of diethylenetriamine and urea, solutions of each amine source in the absence of the halogenated oxidizer can be used to baseline the spectrophotometer. After mixing the hypochlorite solution with each amine source, scans can be obtained. Typically, the hypochlorite peak will be undetectable in the presence of sufficient amounts of diethylenetriamine and urea, but each amine source has a characteristic peak that is indicative of a haloamine.

To determine the absorbance spectrum, a quantity of the haloamine solution can be added to a quartz cuvette and scanned in the spectrophotometer. The resulting spectral profile of the solution demonstrates the presence of the haloamine species. For example, to verify the presence of monochloramine and/or dichloramine in a sample, a sample of the solution is added to a quartz cuvette and the spectral characteristics determined. The spectral scans of samples containing monochloramine or dichloramine are compared to similar scans in the literature (Poskrebyshev et al., 2003). Furthermore, when working with monochloramine, the concentration can be determined by the DPD assay and the height of the absorbance peak at 244 nm. The DPD assay and absorbance peaks at 206 nm and 295 nm can be used to monitor the concentration of dichloramine in solution. The spectral scans can also be used to verify the presence of other haloamine species, e.g., bromamines.

The haloamine can be formed in the process water by sequential or simultaneous addition of the amine source and the halogenated oxidizer. Alternatively, the haloamine can be preformed by combining the amine source and the oxidizer. The haloamine can be added to the aqueous system before the non-oxidizing biocide or the non-oxidizing biocide can be added before the haloamine or they can be added simultaneously. In a preferred embodiment, the haloamine is added to the industrial water prior to the addition of the non-oxidizing biocide. The haloamine can be added pursuant to any known method that provides the desired concentration of the haloamine in the aqueous system.

In one embodiment, the amine source, with an oxidizer and the non-oxidizing biocide are added to the water system simultaneously. The haloamine and the non-oxidizing biocide can be added pursuant to any known method that provides the desired concentration of the haloamine and non-oxidizing biocide in the aqueous system.

In one embodiment, after the controlled addition of the haloamine, the non-oxidizing biocide is then added to the water system. In an embodiment, the non-oxidizing biocide is added after the haloamine is added to the system. The time lag (or incubation period) between the addition of haloamine and non-oxidizing biocide can be, but is not limited to, 3 hours or 2 hours or 1.5 hours or 1 hour or 30 minutes or 15 minutes. Similar to the haloamine addition, the non-oxidizing biocide can be added pursuant to any known method that provides the desired concentration of the non-oxidizing biocide in the aqueous system.

In one embodiment, after the addition of the non-oxidizing biocide, the haloamine is then added to the water system. In an embodiment, the haloamine is added after the non-oxidizing biocide is added to the system. The time lag between the addition of biocide and haloamine can be, but is not limited to, 3 hours or 2 hours or 1.5 hours or 1 hour or 30 minutes or 15 minutes. Similar to the non-oxidizing biocide addition, the haloamine can be added pursuant to any known method that provides the desired concentration of the haloamine in the aqueous system.

The biocide(s) can be added to the system as independent material(s) or in combination with other materials being added to the industrial water system. For example, the biocide(s) can be added with starch, clay, pigment slurries, precipitated calcium carbonate, retention aids, sizing aids, dry and/or wet strength additives, defoamers or other additives used in the manufacturing of pulp or paper products.

The biocides can be continuously, intermittently, or alternatively added to aqueous and/or additive systems.

The above feed strategies for biocide addition is dependent on the growth of the microbial population, the type of problematic microorganisms and the degree of surface fouling in a particular system. For example, the haloamine can be added to a system on a continuous basis while the non-oxidizing biocide is added on an intermittent basis or introduced from the treatment of additive systems (i.e., starch makedown solutions, retention aid makedown solutions, precipitated calcium carbonate slurries, etc.) or other feed points within the aqueous system (i.e., short or long loop, broke chest, saveall, thick stock, blend chest, and/or head box).

### EXAMPLES

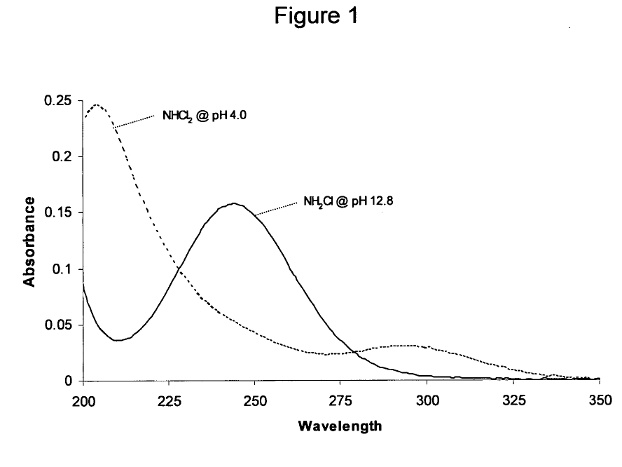

Monochloramine and/or dichloramine was produced in aqueous solution by mixing appropriate concentrations of ammonium hydroxide and sodium hypochlorite. The concentrations of reactants used depended on the desired final concentration of monochloramine or dichloramine. Quantities of reactants were calculated on the basis of achieving 1:1 molar ratios of the amine functionality of ammonium hydroxide and the chlorine functionality of sodium hypochlorite. Monochloramine solutions were formed by combining the two reactants in the proper molar ratios. Dichloramine was formed by adding dilute sulfuric acid to the monochloramine solution to lower the pH to a value between pH 3 to pH 4. Any acid can be used to adjust the pH but for the purposes described herein, 0.1% (w/v) sulfuric acid was used to decrease the pH of the monochloramine solution. The prepared solutions of monochloramine or dichloramine had absorbance profiles similar to that depicted in FIG. 1.

For the microtiter assays used in the following examples, starting solutions of monochloramine and dichloramine were prepared. The concentration of monochloramine and dichloramine in the starting solutions was 2,500 ppm (as Cl⁻). These solutions were then diluted with deionized water to concentrations of 200 ppm (as Cl⁻). Appropriate volumes of each chloramine solution were added to the microtiter plate wells in order to achieve the desired final concentrations. The concentrations used in the assays were dependent on the sensitivities of the bacterial cells to the compounds tested.

For the experiments described herein monochloramine and dichloramine solutions were prepared as described above. The concentration of monochloramine or dichloramine in each solution was determined by measuring the concentration of chlorine by the DPD method. The efficacy of the active materials and blends was determined using a dose protocol. The actives were evaluated in synthetic white water with pH values of 5.5, 7.0, and 8.0. The materials were tested against an artificial bacterial consortium containing approximately equal numbers of six bacterial strains. Although the test strains were representative of organisms present in paper mill systems, the effect is not limited to these bacteria. Two of the strains were Klebsiella pneumonia (ATCC 13883) and Pseudomonas aeruginosa (ATCC 15442).

The other four strains were isolated from papermill systems and have been identified as Curtobacterium flaccumfaciens, Burkholderia cepacia, Bacillus maroccanus, and Pseudomonas glathei. Each strain was inoculated at 37° C. overnight, and then suspended in sterile saline. Equal volumes of each strain were then combined to prepare the consortium. The bacterial consortium was distributed into the wells of a microtiter plate in the presence and absence of selected concentrations of the active materials. The microiter plates were incubated at 37° C. Optical density (O.D.) readings at 650 nm were taken initially (t₀) and after time 4 hours (t₄) of incubation.

The raw data was converted to “bacterial growth inhibition percentages” according to the following formula:
% Inhibition=[(a−b)÷a]*100
where:
a=(O.D. of control at tₙ)−(O.D. of control at t₀); and
b=(O.D. of treatment at tₙ)−(O.D. of treatment at t₀).

The inhibition values were plotted versus dosage for each active and the particular blend. This resulted in a dose response curve from which the dosage to yield 50% inhibition (I₅₀) was calculated. In the examples (tables) below, the I₅₀ values are expressed as parts per million (ppm) of active material.

The synergism index (SI) was calculated by the equations described by Kull et al. (1961), Applied Microbiology 9, 538-541, which is incorporated herein by reference in its entirety. The values were based on the amount needed to achieve a specified end point. The end point selected for these studies was 50% inhibition of bacterial growth. For the invention described herein, the SI was calculated using the following equation;
Synergy Index (SI)=(QA−Qa)+(QB+Qb)
where:
QA=quantity of compound A in mixture, producing the end point;
Qa=quantity of compound A, acting alone, producing the end point;
QB=quantity of compound B in mixture, producing the end point; and
Qb=quantity of compound B, acting alone, producing the end point.

If SI is less than 1, then synergism is suggested; if SI is greater than 1, then antagonism is suggested; and if Si is equal to 1, then an additive effect is suggested.

Quantities and/or concentrations of haloamine were measured by the Hach DPD chlorine test as described hereinabove.

The following examples are intended to be illustrative of the present invention. However, these examples are not intended to limit the scope of the invention or its protection in any way. The examples illustrate the conditions under which a synergistic relationship was obtained with the compositions of the present invention.

In the following examples, the synergy index results are presented with the corresponding amounts and weight ratios of haloamine to non-oxidizing biocide. In each example, the ratios of the actives for which there is a synergy index of less than 1 is bold and italicized.

### Example 1

This example shows the synergistic activity between monochloramine (MCA) and sodium N-dimethyldithiocarbamate (carbamate) under a concurrent feed strategy against an artificial bacterial consortium in synthetic white water at pH 5.5, 7.0, and 8.0.

TABLE 1

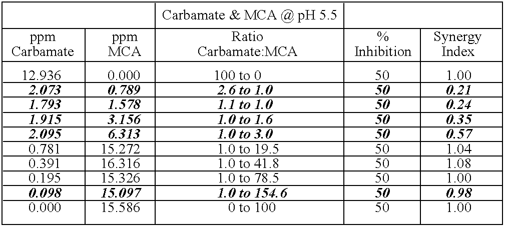

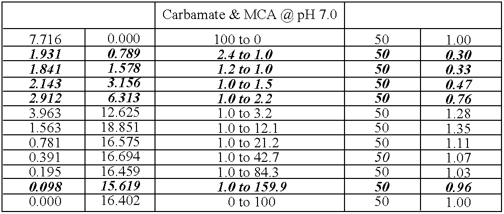

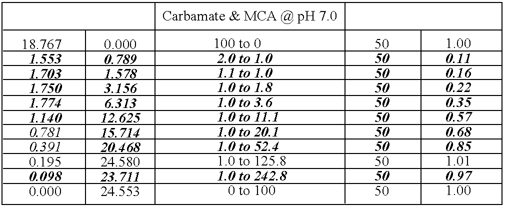

### Example 2

This example shows the synergistic activity between dichloramine (DCA) and sodium N-dimethyldithiocarbamate (carbamate) under a concurrent feed strategy against an artificial bacterial consortium in synthetic white water at pH 5.5, 7.0, and 8.0.

TABLE 2

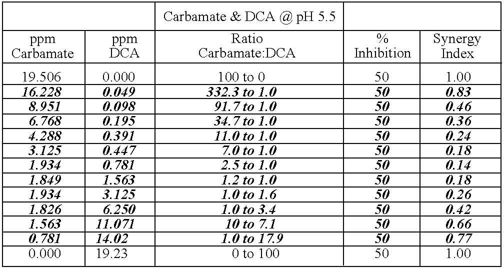

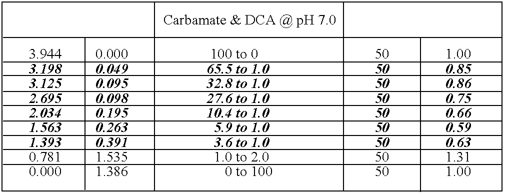

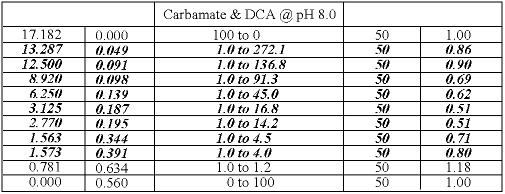

### Example 3

This example shows the synergistic activity between monochloramine and 2,2-Dibromo-3-nitrilopropionamide (DBNPA) under a concurrent feed strategy against an artificial bacterial consortium in synthetic white water at pH 5.5, 7.0, and 8.0.

TABLE 3

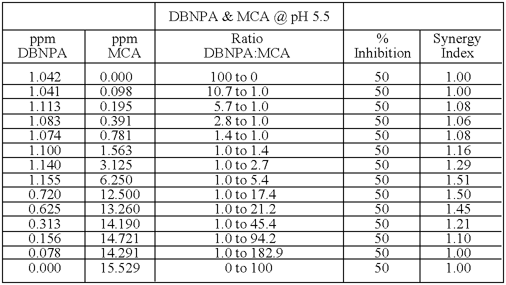

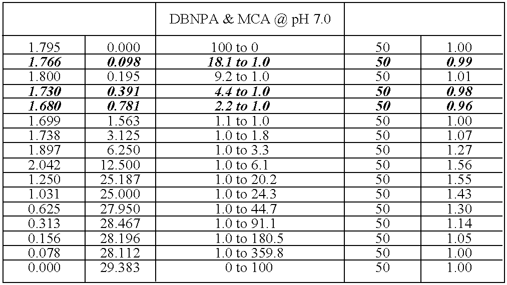

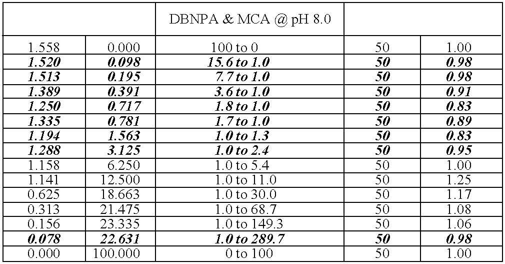

### Example 4

This example shows the synergistic activity between dichloramine and 2,2-Dibromo-3-nitrilopropionamide (DBNPA) under a concurrent feed strategy against an artificial bacterial consortium in synthetic white water at pH 5.5, 7.0, and 8.0.

TABLE 4

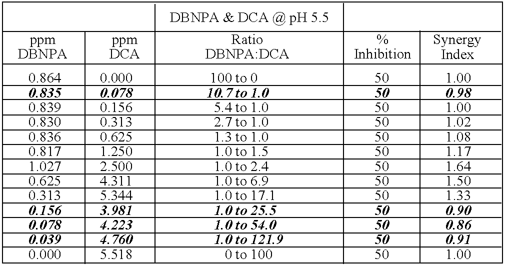

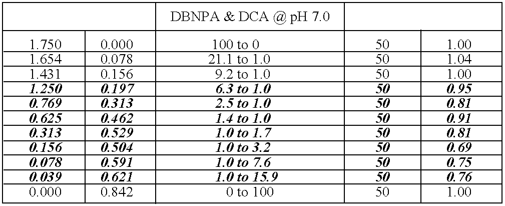

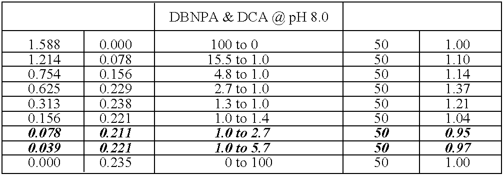

### Example 5

This example shows the synergistic activity between monochloramine and 4,5-Dichloro-1,2-dithiolone (Dithiol) under a concurrent feed strategy against an artificial bacterial consortium in synthetic white water at pH 5.5, 7.0, and 8.0.

TABLE 5

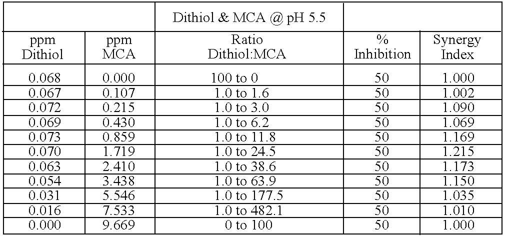

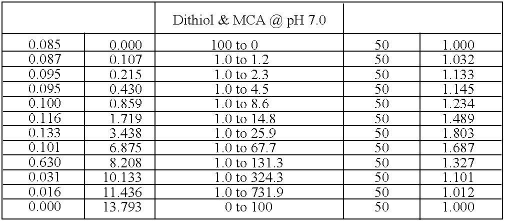

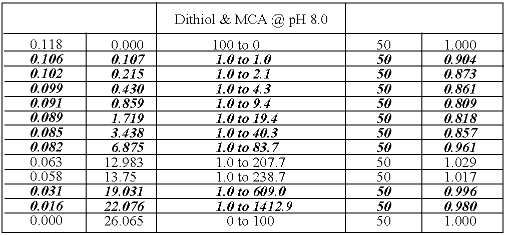

### Example 6

This example shows the synergistic activity between dichloramine and 4,5-Dichloro-1,2-dithiolone (Dithiol) under a concurrent feed strategy against an artificial bacterial consortium in synthetic white water at pH 5.5, 7.0, and 8.0.

TABLE 6

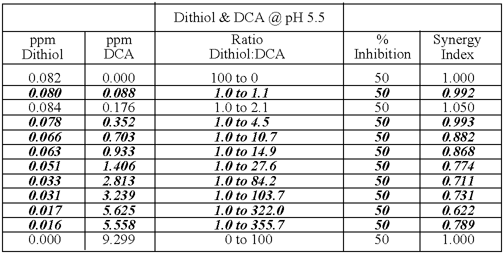

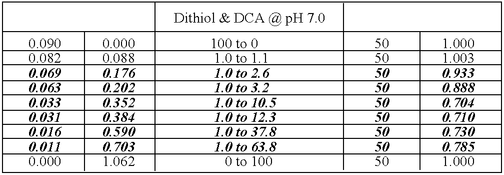

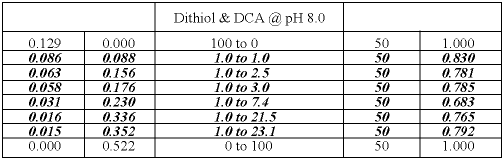

### Example 7

This example shows the synergistic activity between monochloramine and sulfamic acid (SA) under a concurrent feed strategy against an artificial bacterial consortium in synthetic white water at pH 5.5, 7.0 and 8.0.

TABLE 7

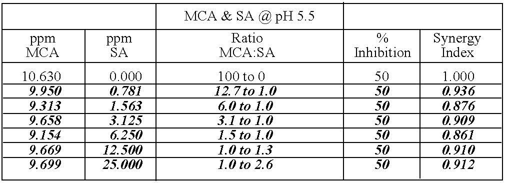

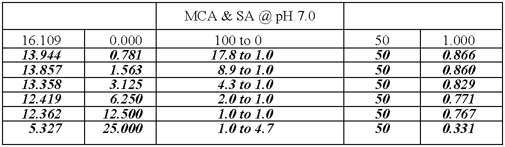

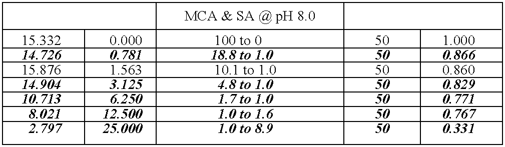

### Example 8

This example shows the synergistic activity between dichloramine and sulfamic acid (SA) under a concurrent feed strategy against an artificial bacterial consortium in synthetic white water at pH 5.5, 7.0 and 8.0.

TABLE 8

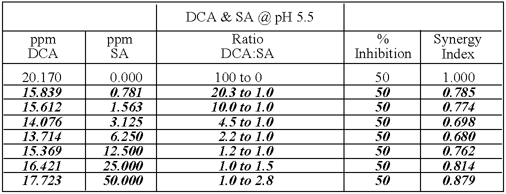

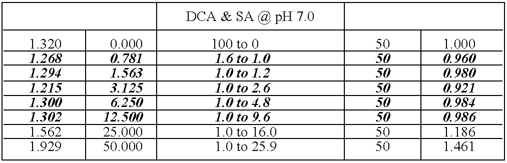

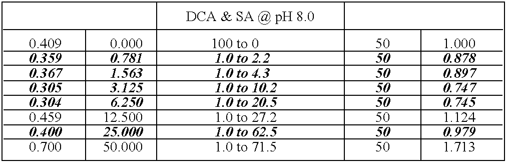

### Example 9

This example shows the synergistic activity between monochloramine and Bis(trichloromethyl)sulfone (Sulfone) under a concurrent feed strategy against an artificial bacterial consortium in synthetic white water at pH 5.5, 7.0, and 8.0.

TABLE 9

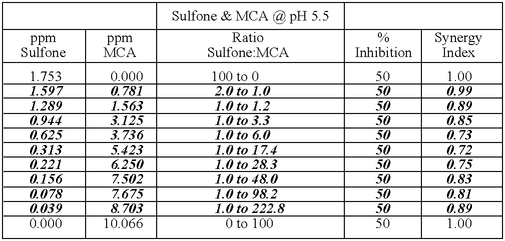

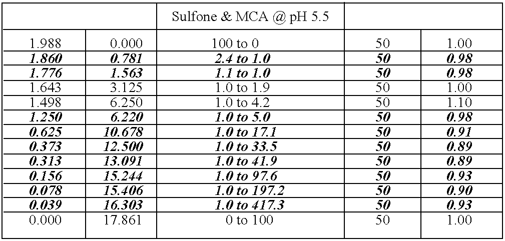

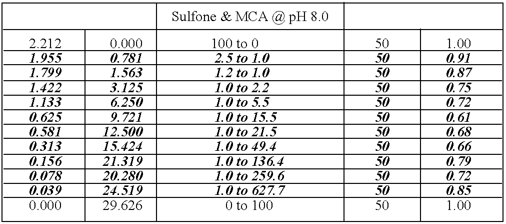

### Example 10

This example shows the synergistic activity between dichloramine and Bis(trichloromethyl)sulfone (Sulfone) under a concurrent feed strategy against an artificial bacterial consortium in synthetic white water at pH 5.5, 7.0, and 8.0.

TABLE 10

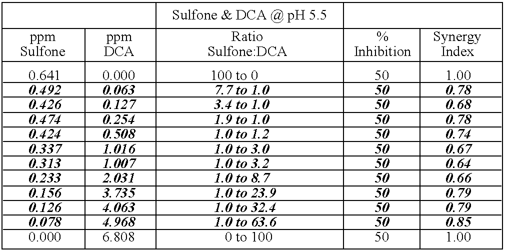

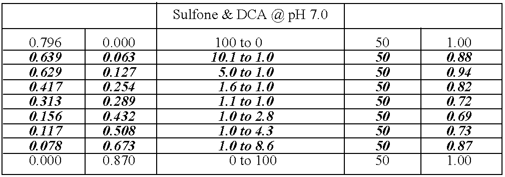

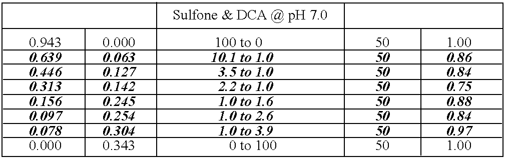

### Example 11

This example shows the synergistic activity between monochloramine and bromonitrostyrene (BNS) under a concurrent feed strategy against an artificial bacterial consortium in synthetic white water at pH 5.5, 7.0, and 8.0.

TABLE 11

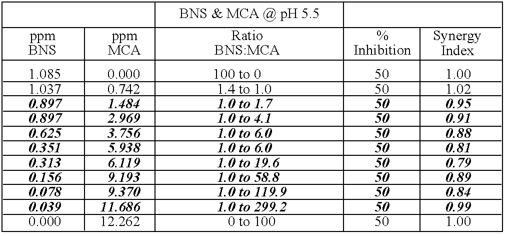

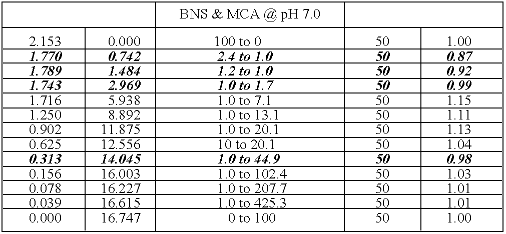

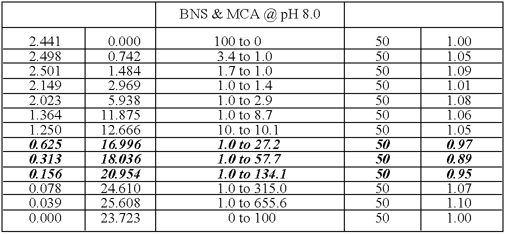

### Example 12

This example shows the synergistic activity between dichloramine and bromonitrostyrene (BNS) under a concurrent feed strategy against an artificial bacterial consortium in synthetic white water at pH 5.5, 7.0, and 8.0.

TABLE 12

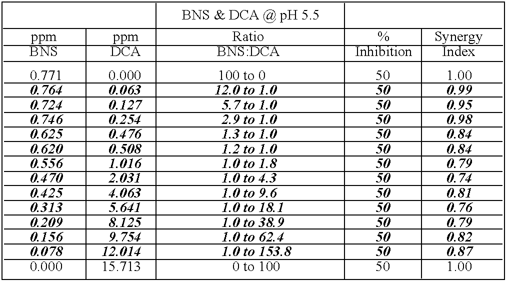

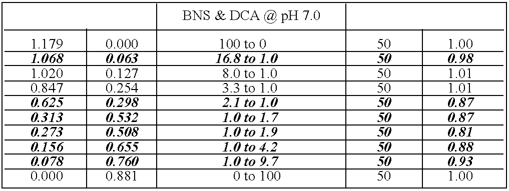

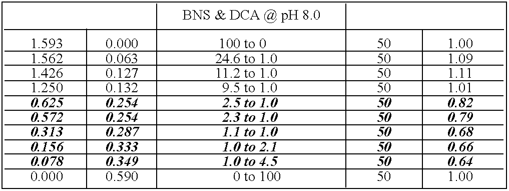

### Example 13

This example shows the synergistic activity between monochloramine and Bis-,4-(bromoacetoxy)-2-butene (BBAB) under a concurrent feed strategy against an artificial bacterial consortium in synthetic white water at pH 5.5, 7.0, and 8.0.

TABLE 13

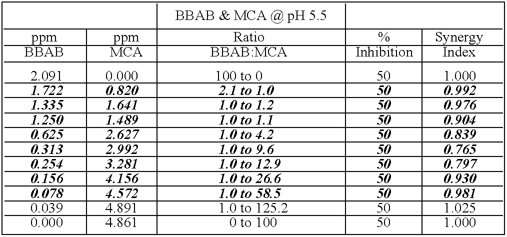

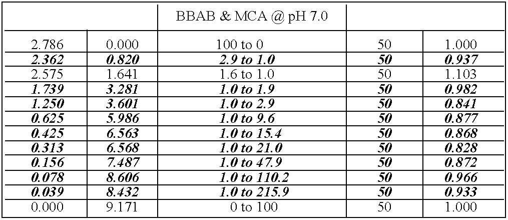

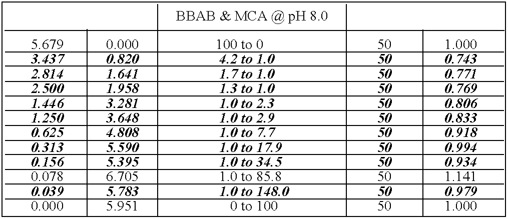

### Example 14

This example shows the synergistic activity between dichloramine and bis-,4-(bromoacetoxy)-2-butene (BBAB) under a concurrent feed strategy against an artificial bacterial consortium in synthetic white water at pH 5.5, 7.0 and 8.0.

TABLE 14

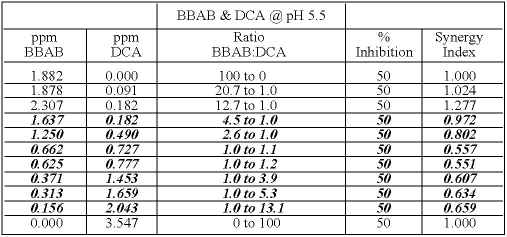

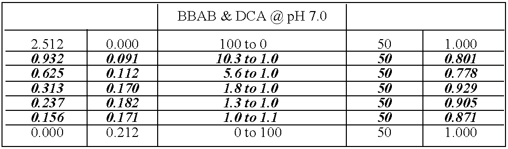

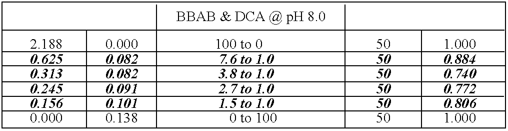

### Example 15

This example shows the synergistic activity between monochloramine and 2-Bromo-2-nitro-propane-1,3-diol (BNPD) under a concurrent feed strategy against an artificial bacterial consortium in synthetic white water at pH 5.5, 7.0, and 8.0.

TABLE 15

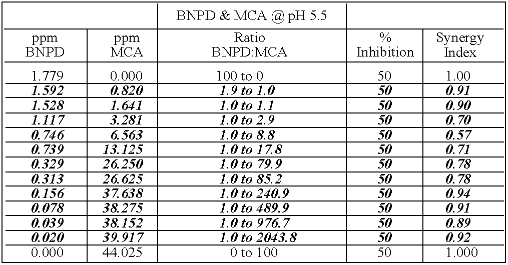

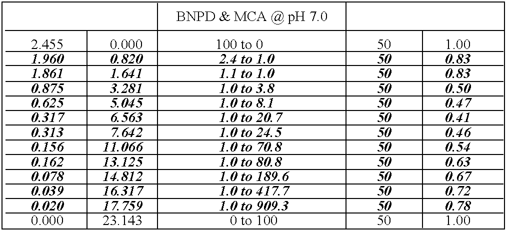

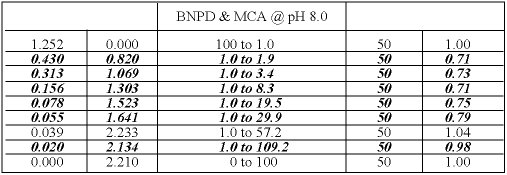

### Example 16

This example shows the synergistic activity between dichloramine and 2-Bromo-2-nitro-propane-1,3-diol (BNPD) under a concurrent feed strategy against an artificial bacterial consortium in synthetic white water at pH 5.5, 7.0, and 8.0.

TABLE 16

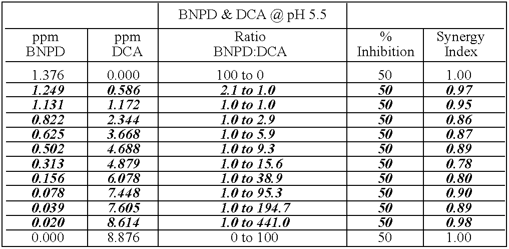

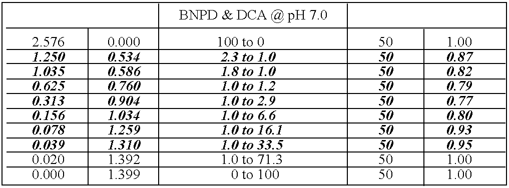

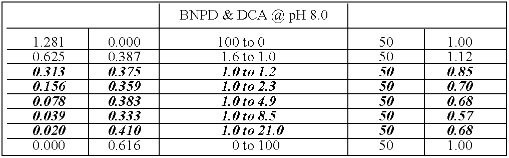

### Example 17

This example shows the synergistic activity between monochloramine and a mixture of 2-Methyl-4-isothiazolin-3-one & 5-Chloro-2-methyl-4-isothiazolin-3-one (Iso) under a concurrent feed strategy against an artificial bacterial consortium in synthetic white water at pH 5.5, 7.0, and 8.0.

TABLE 17

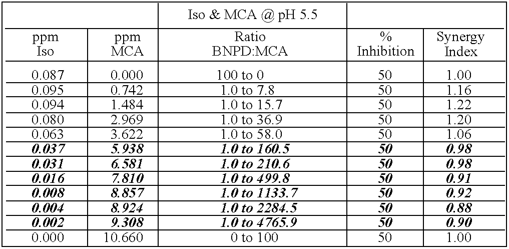

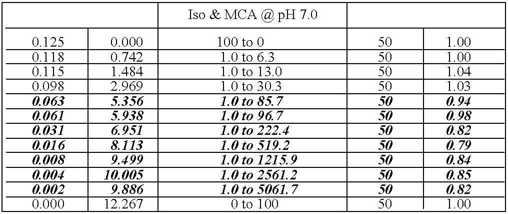

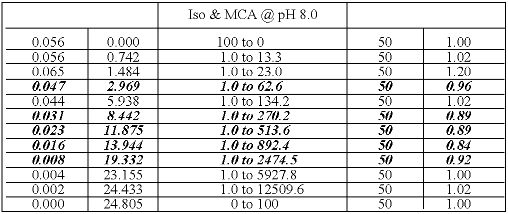

### Example 18

This example shows the synergistic activity between dichloramine (prepared using ammonium sulfate) and a mixture of 2-methyl-4-isothiazolin-3-one & 5-chloro-2-methyl-4-isothiazolin-3-one (iso) under a concurrent feed strategy against an artificial bacterial consortium in synthetic white water at pH 5.5, 7.0, and 8.0.

TABLE 18

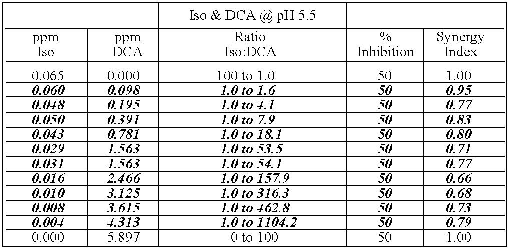

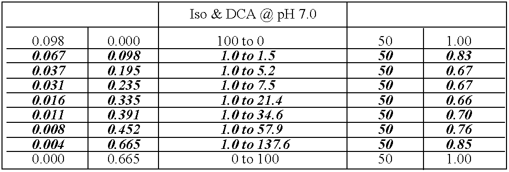

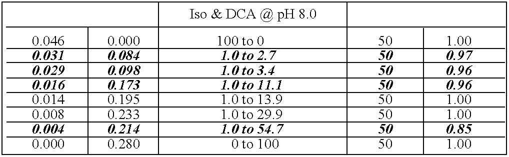

### Example 19

This example shows the synergistic activity between dichloramine (prepared using ammonium hydroxide) and a mixture of 2-methyl-4-isothiazolin-3-one & 5-chloro-2-methyl-4-isothiazolin-3-one (Iso) under a concurrent feed strategy against an artificial bacterial consortium in synthetic white water at pH 5.5, 7.0, and 8.0.

TABLE 19

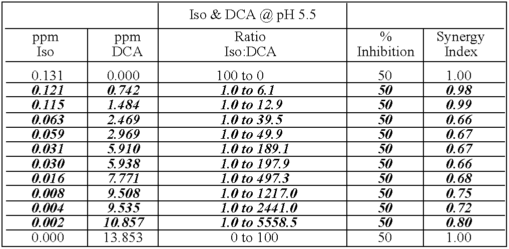

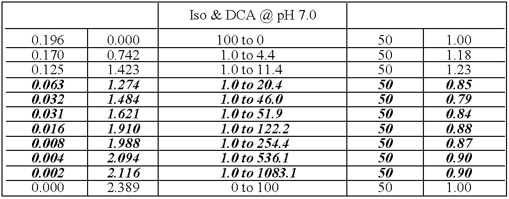

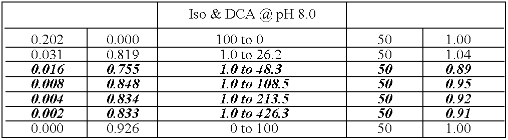

### Example 20

This example shows the synergistic activity between monochloramine and glutaraldehyde (Glut) under a concurrent feed strategy against an artificial bacterial consortium in synthetic white water at pH 5.5, 7.0, and 8.0.

TABLE 20

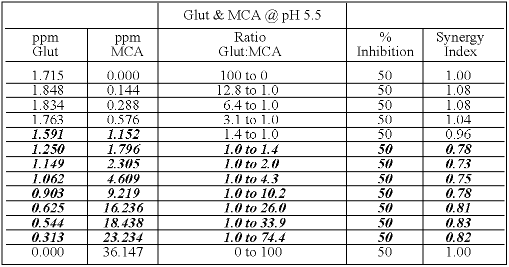

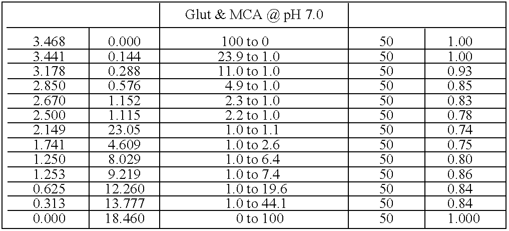

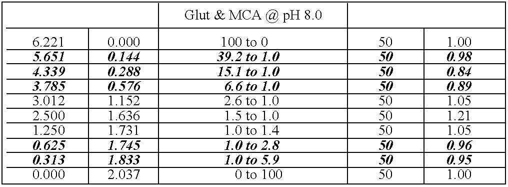

### Example 21

This example shows the synergistic activity between dichloramine and glutaraldehyde (Glut) under a concurrent feed strategy against an artificial bacterial consortium in synthetic white water at pH 5.5, 7.0, and 8.0.

TABLE 21

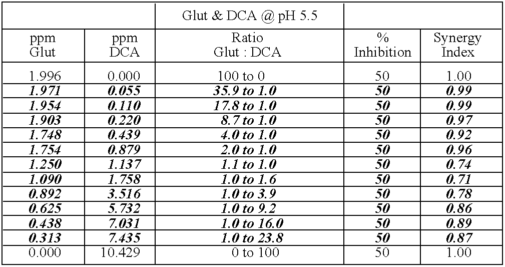

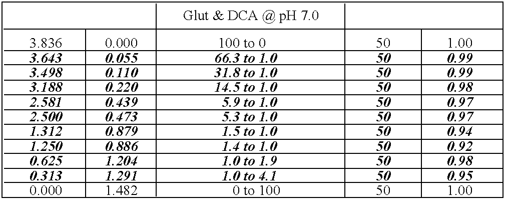

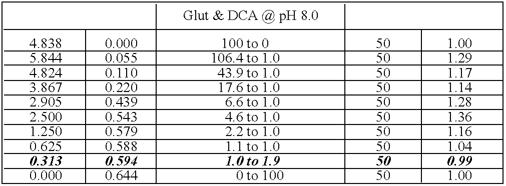

### Example 22

This example shows the synergistic activity between monochloramine and dodecylguanidine hydrochloride (DGH) under a concurrent feed strategy against an artificial bacterial consortium in synthetic white water at pH 5.5, 7.0 and 8.0.

TABLE 22

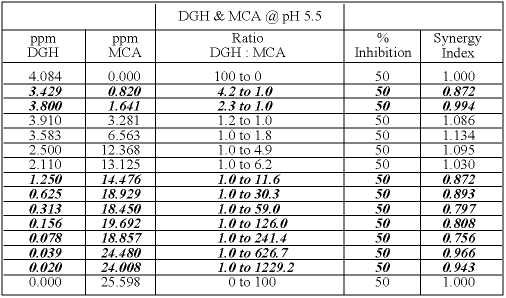

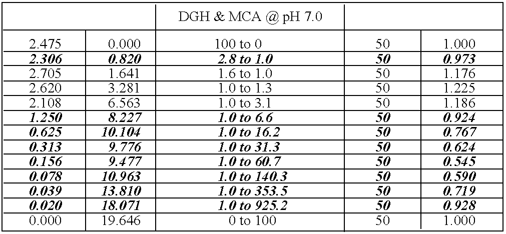

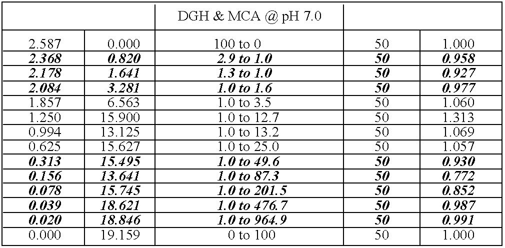

### Example 23

This example shows the synergistic activity between dichloramine and dodecylguanidine hydrochloride (DGH) under a concurrent feed strategy against an artificial bacterial consortium in synthetic white water at pH 5.5, 7.0 and 8.0.

TABLE 23

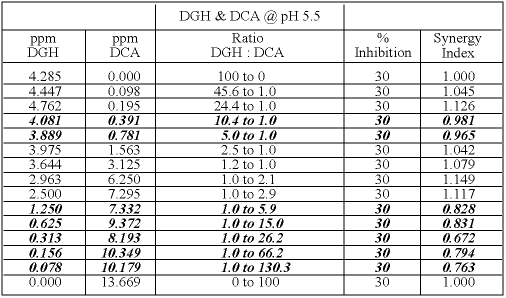

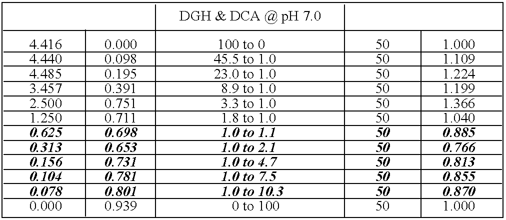

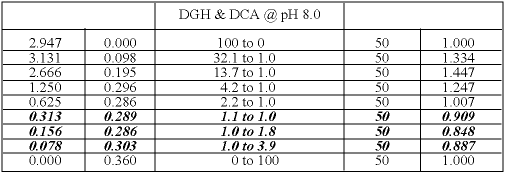

### Example 24

This example shows the synergistic activity between monochloramine and methylene bis(thiocyanate) (MBTC) under a concurrent feed strategy against an artificial bacterial consortium in synthetic white water at pH 5.5, 7.0 and 8.0.

TABLE 24

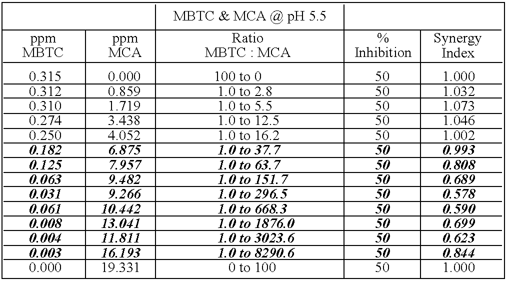

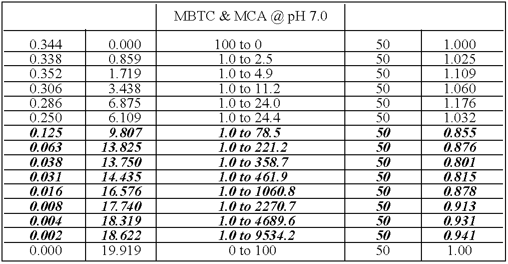

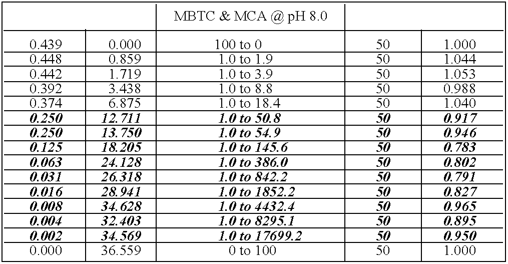

### Example 25

This example shows the synergistic activity between dichloramine and methylene bis(thiocyanate) (MBTC) under a concurrent feed strategy against an artificial bacterial consortium in synthetic white water at pH 5.5, 7.0 and 8.0.

TABLE 25

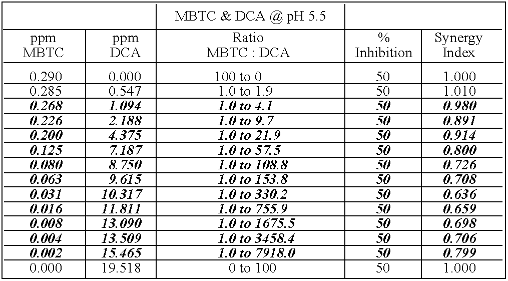

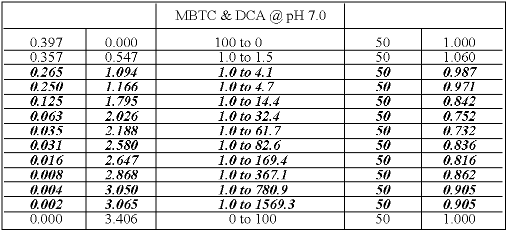

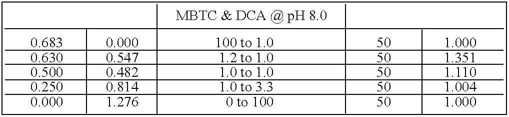

### Example 26

This example shows the synergistic activity between monochloramine and 3,5-Dimethyl-tetrahydro-1,3,5-2H-thiadiazine-2-thione (Dazomet) under a concurrent feed strategy against an artificial bacterial consortium in synthetic white water at pH 5.5, 7.0 and 8.0.

TABLE 26

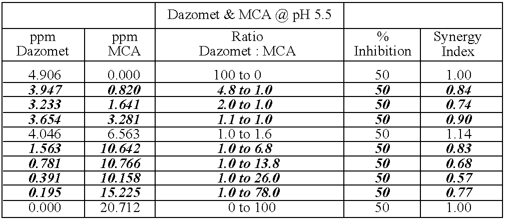

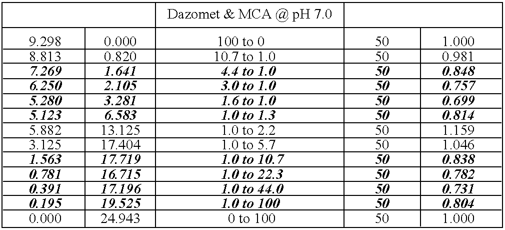

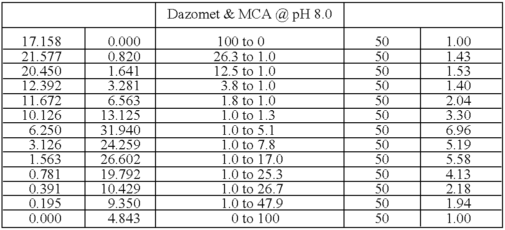

### Example 27

This example shows the synergistic activity between dichloramine and 3,5-Dimethyl-tetrahydro-1,3,5-2H-thiadiazine-2-thione (Dazomet) under a concurrent feed strategy against an artificial bacterial consortium in synthetic white water at pH 5.5, 7.0 and 8.0.

TABLE 27

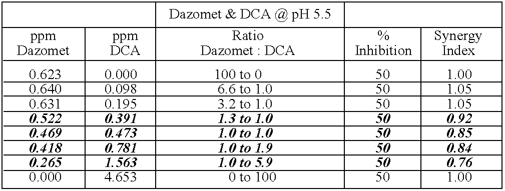

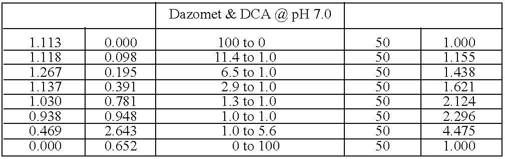

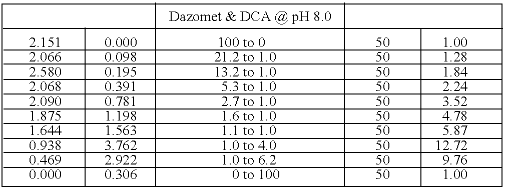

### Example 28

This example shows the synergistic activity between monochloramine and 1,2-Dibromo-2,4-dicyanobutane (DBDCB) under a concurrent feed strategy against an artificial bacterial consortium in synthetic white water at pH 5.5, 7.0 and 8.0.

TABLE 28

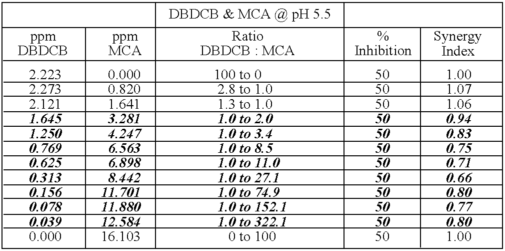

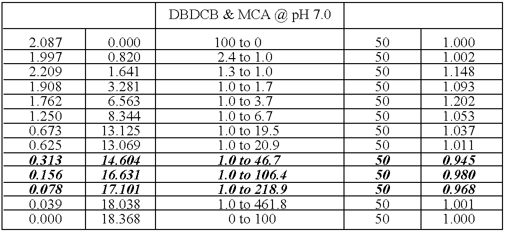

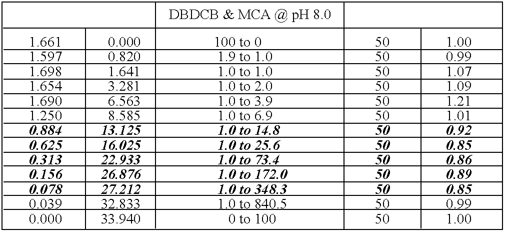

### Example 29

This example shows the synergistic activity between dichloramine and 1,2-dibromo-2,4-dicyanobutane (DBDCB) under a concurrent feed strategy against an artificial bacterial consortium in synthetic white water at pH 5.5, 7.0 and 8.0.

TABLE 29

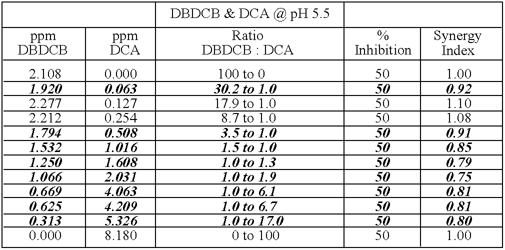

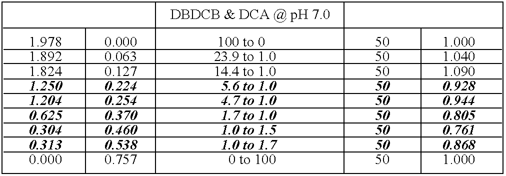

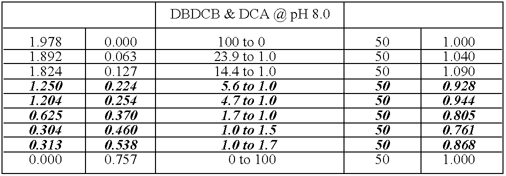

### Example 30

This example shows the synergistic activity between monochloramine and N-alkyl (60% Cl₄, 30% C₁₆, 5% C₁₂, 5% C₁₈) dimethyl benzyl ammonium chloride (Quat) under a concurrent feed strategy against an artificial bacterial consortium in synthetic white water at pH 5.5, 7.0, and 8.0.

TABLE 30

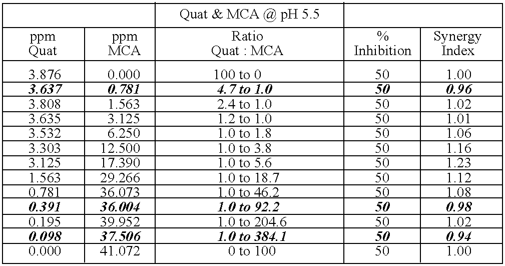

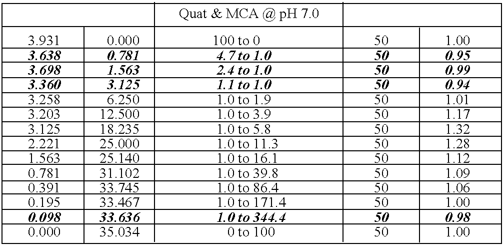

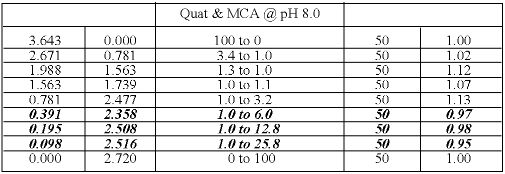

### Example 31

This example shows the synergistic activity between dichloramine and N-alkyl (60% Cl₄, 30% C₁₆, 5% C₁₂, 5% C₁₈) dimethyl benzyl ammonium chloride (Quat) under a concurrent feed strategy against an artificial bacterial consortium in synthetic white water at pH 5.5, 7.0, and 8.0.

TABLE 31

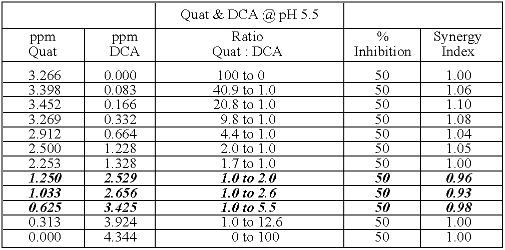

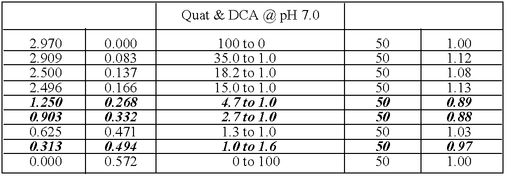

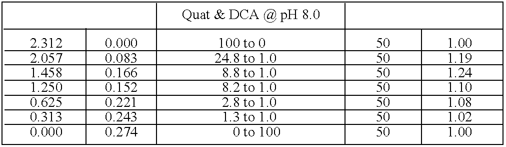

While this invention has been described with respect to particular embodiments thereof, it is apparent that numerous other forms and modifications of the invention will be obvious to those skilled in the art. The appended claims and this invention generally should be construed to cover all such obvious forms and modifications which are within the true spirit and scope of the present invention. Each reference, including articles, patents, patent applications, and patent application publications, cited in the present application is incorporated herein by reference in its entirety.

What is claimed is:

1. A method for controlling the growth of microorganisms in an aqueous system comprising adding an effective amount of haloamine and a non-oxidizing biocide to said aqueous system, wherein said effective amount of haloamine and non-oxidizing biocide provides a synergy index of less than 1.

2. The method of claim 1, wherein the haloamine is selected from the group consisting of chloramines, bromamines, or mixtures thereof.

3. The method of claim 1, wherein the haloamine is monochloramine, dichloramine, or mixture thereof.

4. The method of claim 1, wherein the haloamine is the reaction product formed by mixing an amine source with a halogenated oxidizer.

5. The method of claim 4, wherein the amine source for the haloamine is an ammonium salt selected from the group consisting of ammonium acetate, ammonium bicarbonate, ammonium bromide, ammonium carbonate, ammonium chloride, ammonium citrate, ammonium nitrate, ammonium oxalate, ammonium persulfate, ammonium phosphate, ammonium sulfate, ferric ammonium sulfate, ferrous ammonium sulfate, and combinations thereof.

6. The method of claim 4, wherein the amine source for the haloamine is selected from the group of ammonia and ammonium hydroxide.

7. The method of claim 4, wherein the amine source is ammonium sulfate.

8. The method of claim 4, wherein the amine source is selected from the group consisting of ethanolamine, ethylenediamine, diethanolamine, triethanolamine, triethylenetetramine, dibutylamine, tributylamine, glutamine, diphenylamine, hydrazine, urea, guanidine, biguanidine, sulfamate, primary and secondary nitrogen containing polymers, and combinations thereof.

9. The method of claim 4, wherein the halogenated oxidizer is hypochlorous acid or hypochlorite.

10. The method of claim 4, wherein the halogenated oxidizer is hypobromous acid or hypobromite.

11. The method of claim 1, wherein the non-oxidizing biocide is selected from the group consisting of 2,2-dibromo-3-nitrilopropionamide (DBNPA), glutaraldehyde, methylene bisthiocyanate (MBTC), thiazole derivatives, isothiazolinone derivatives, 5-chloro-2-methyl-4-isothiazolin-3-one (CMIT), 2-methyl-4-isothiazolin-3-one (MIT), 2-bromo-2-nitro-propane-1,3-diol (Bronopol), a long chain quaternary ammonium compound, an aliphatic diamine, a guanidine, biguanidine, n-dodecylguanidine hydrochloride, n-alkyl dimethyl benzyl ammonium chloride, didecyl dimethyl ammonium chloride, 1,2-dibromo-2,4-dicyanobutane, 2,2-dibromo-3-nitrilopropionamide (DBNPA), bis(trichloromethyl)sulfone, 4,5-dichloro-1,2-dithiol-3-one, 2-bromo-2-nitrostyrene, 5-chloro-2-methyl-4-isothiazolin-3-one (CMIT), 2-methyl-4-isothiazolin-3-one (MIT), and combinations thereof.

12. The method of claim 1, wherein the weight ratio of haloamine to the non-oxidizing biocide is from about 20,000:1 to about 1:10,000.

13. The method of claim 1, wherein the weight ratio of haloamine to the non-oxidizing biocide is from about 10,000:1 to about 1:1,000.

14. The method of claim 1, wherein the weight ratio of haloamine to the non-oxidizing biocide is from about 5,000:1 to about 1:500.

15. The method of claim 1, wherein the weight ratio of haloamine to the non-oxidizing biocide is from about 1,000:1 to about 1:100.

16. The method of claim 1, wherein the weight ratio of haloamine to the non-oxidizing biocide is from about 1,000:1 to about 1:50.

17. The method of claim 1, wherein the amount of the haloamine ranges from about 0.1 to about 100 parts per million (ppm) by weight on an active level basis and the amount of the non-oxidizing biocide ranges from about 0.001 to about 40 ppm by weight on an active level basis.

18. The method of claim 1, wherein the amount of haloamine ranges from about 0.5 to about 50 ppm by weight on an active level basis and the amount of the non-oxidizing biocide ranges from about 0.001 to about 40 ppm by weight on an active level basis.

19. The method of claim 1, wherein the haloamine and the non-oxidizing biocide are added simultaneously to the aqueous system.

20. The method of claim 1, wherein the haloamine is added to the aqueous system prior to the addition of the non-oxidizing biocide.

21. The method of claim 1, wherein the non-oxidizing biocide is added to the aqueous system prior to the addition the haloamine.

22. The method of claim 1, wherein the aqueous system is an industrial water system.

23. The method of claim 22, wherein the aqueous system is selected from the group consisting of a pulp and paper mill water system, cooling water system, and mining process waters.

24. The method of claim 22 wherein the industrial system comprises a pulp and paper mill water system and said haloamine is introduced into one or more of the process waters comprising pulp, additives, fillers, or other materials used in papermaking.

25. A synergistic mixture comprising a haloamine and a non-oxidizing biocide in an aqueous system wherein the weight ratio of haloamine to the non-oxidizing biocide is from about 1,000:1 to about 1:50, the amount of the haloamine ranges from about 0.1 to about 50 parts per million (ppm) by weight on an active level basis, and the amount of the non-oxidizing biocide ranges from about 0.001 to about 40 ppm by weight on an active level basis.
